(19) United States
(12) Patent Application Publication
(10) Pub. No.: US 2025/0360471 A1
(43) Pub. Date: Nov. 27, 2025

(54) APPARATUS FOR THE TREATMENT OF POWDER, GRAIN, PASTE PRODUCTS OR THE LIKE

(71) Applicant: WAMGROUP S.P.A., MODENA (MO) (IT)

(72) Inventors: Vainer MARCHESINI, MODENA (MO) (IT); Mirko FIORINI, MODENA (MO) (IT)

(73) Assignee: WAMGROUP S.P.A., MODENA (MO) (IT)

(21) Appl. No.: 19/213,042

(22) Filed: May 20, 2025

(30) Foreign Application Priority Data
May 27, 2024 (IT) 102024000011992

(51) Int. Cl. B01F 25/20; B01F 25/31; B01F 35/71; B01F 101/09

(52) U.S. Cl. CPC B01F 25/282; B01F 25/31; B01F 35/71805; B01F 2101/09

(57) ABSTRACT

An apparatus for the treatment of powder, grain, paste products or the like has a treatment chamber provided with a loading mouth for at least one powder, grain or similar product and with a discharge mouth for the product; a closing cap for the discharge mouth; and at least one annular manifold, which is obtained in the discharge mouth or in the closing cap and communicates with the outside through an annular outlet channel configured to feed a compressed air flow along an inner surface of the discharge mouth and/or along an outer surface of the closing cap.

### CROSS-REFERENCE TO RELATED APPLICATIONS

This patent application claims priority from Italian patent application no. 102024000011992 filed on May 27, 2024, the entire disclosure of which is incorporated herein by reference.

### TECHNICAL FIELD

The invention relates to an apparatus for the treatment of powder, grain, paste products or the like.

The invention especially advantageously applies to an apparatus for mixing powder, grain, paste products or the like, to which explicit reference will be made in the description below without because of this lacking generality.

### BACKGROUND

In the field of mixing powder, grain, paste products or the like, it is known to provide an apparatus comprising a mixing chamber with a cylindrical shape; a loading mouth for feeding at least one powder, grain, paste product or the like into the mixing chamber; a discharge mouth with a tubular shape for discharging at least said product out of the mixing chamber; and a closing cap for closing the discharge mouth.

The mixing chamber is axially closed by two end heads and is associated with a mixing device comprising a transmission shaft coupled to the end heads in a rotary manner and provided with a plurality of mixing tools, such as for example blades or plowshares, distributed along the transmission shaft.

The closing cap is movable between an opening position, in which the product is discharged by gravity out of the mixing chamber through the discharge mouth, and a closing position, in which the closing cap is hermetically coupled in a fluid-tight manner to the discharge mouth through the interposition of an annular gasket.

The apparatus is further provided with a pneumatic blowing unit configured to remove the product accumulated on the inner surface of the discharge mouth and/or on the outer surface of the closing cap during the discharge of the product through the discharge mouth.

The pneumatic blowing unit comprises a plurality of feeding ducts, which are obtained through the discharge mouth, are evenly distributed around a longitudinal axis of the discharge mouth and are connected to a source of compressed air.

The feeding ducts open outwards in the area of the inner surface of the discharge mouth so as to feed a flow of compressed air against the outer surface of the closing cap.

Known apparatuses for the treatment of powder, grain, paste products or the like of the type described above suffer from some drawbacks, which are mainly due to the fact that the feeding ducts have a relatively reduced effectiveness and efficiency and do not guarantee a complete removal of the products from the inner surface of the discharge mouth and from the outer surface of the closing cap.

### SUMMARY

The object of the invention is to provide an apparatus for the treatment of powder, grain, paste products or the like, which is designed to eliminate the aforementioned drawbacks in a straightforward, relatively low-cost manner.

According to the invention, there is provided an apparatus for the treatment of powder, grain, paste products or the like according to the appended claims.

### BRIEF DESCRIPTION OF THE DRAWINGS

The invention will now be described with reference to the accompanying drawings showing a non-limiting embodiment thereof, wherein:

FIG. 1 is a schematic perspective view, with parts removed for greater clarity, of a preferred embodiment of the apparatus according to the invention;

FIG. 2 is a schematic longitudinal section, with parts removed for greater clarity, of a detail of the apparatus of FIG. 1;

FIG. 3 is a schematic longitudinal section, with parts removed for greater clarity, of a first detail of FIG. 2; and

FIG. 4 is a schematic longitudinal section, with parts removed for greater clarity, of a second detail of FIG. 2.

### DESCRIPTION OF EMBODIMENTS

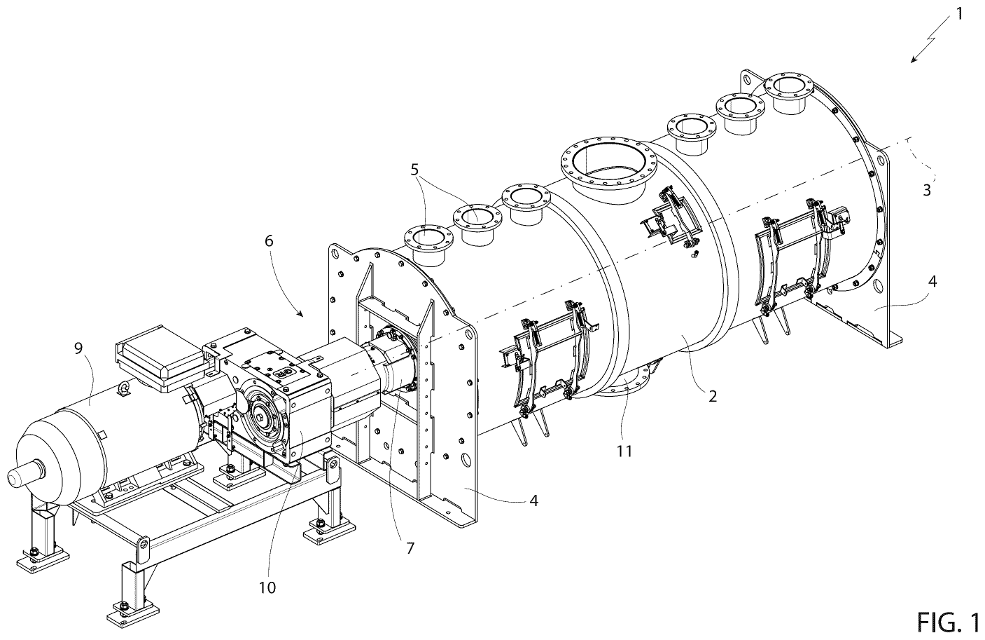

With reference to FIG. 1, number 1 indicates, as a whole, an apparatus for the treatment of powder, grain, paste products or the like, in particular an apparatus for mixing powder products, in particular an apparatus for mixing powder products with a liquid additive such as, for example, water.

The apparatus 1 comprises a mixing chamber 2 with a substantially cylindrical shape, which has a substantially horizontal longitudinal axis 3 and is axially closed by two end heads 4.

The chamber 2 is provided with at least one loading mouth 5, in this specific case a plurality of loading mouths 5, each of which protrudes upwards from the chamber 2 and allows at least one powder, grain or similar product to be fed into the chamber 2.

The chamber 2 is further provided with a known mixing device 6 comprising a transmission shaft 7, which is coupled to the end heads 4 in a rotary manner so as to rotate inside the chamber 2 around the axis 3 and is provided with a plurality of known mixing tools, which are not shown and are distributed along the shaft 7.

The shaft 7 is caused to rotate around the axis 3 by an electric motor 9 mounted outside the chamber 2 and connected to the shaft 7 through the interposition of a reduction unit 10.

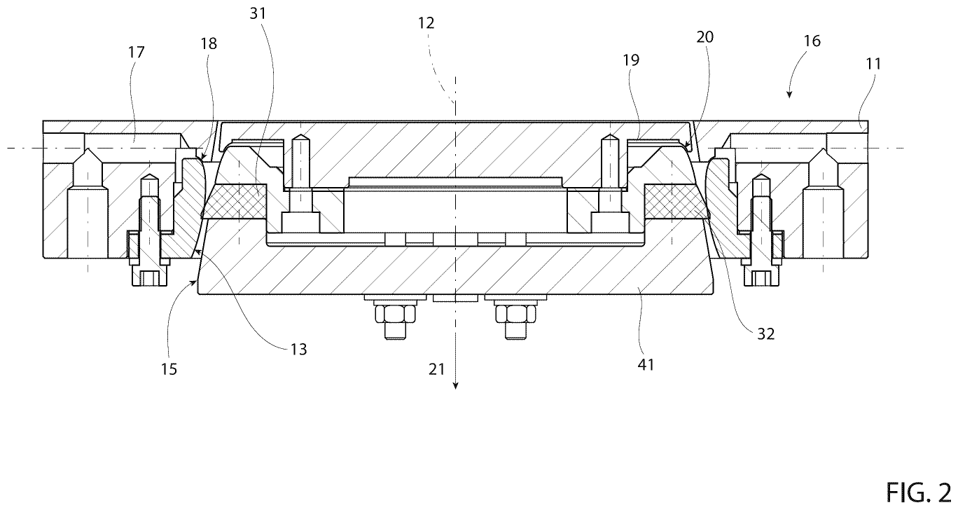

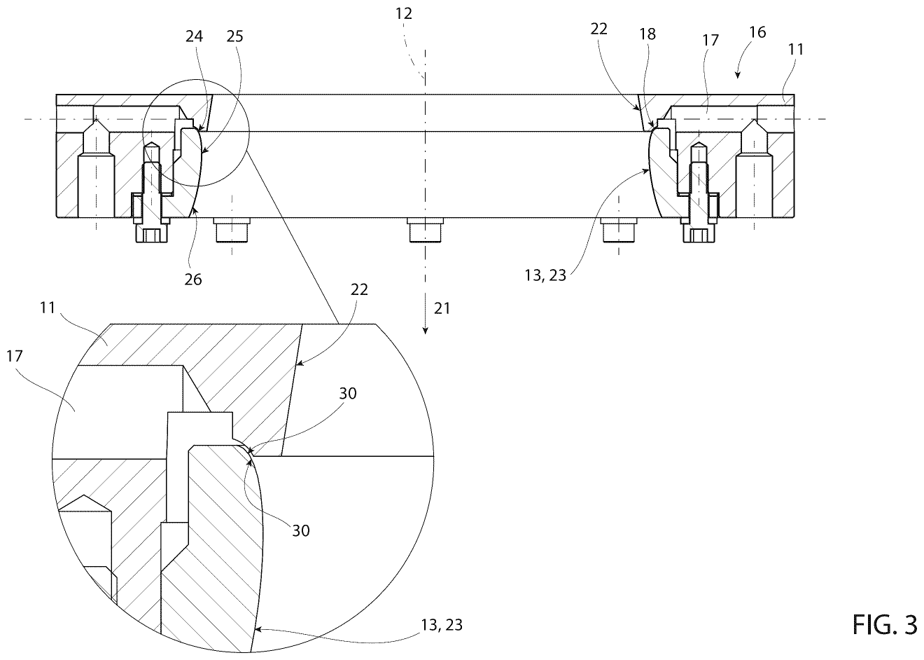

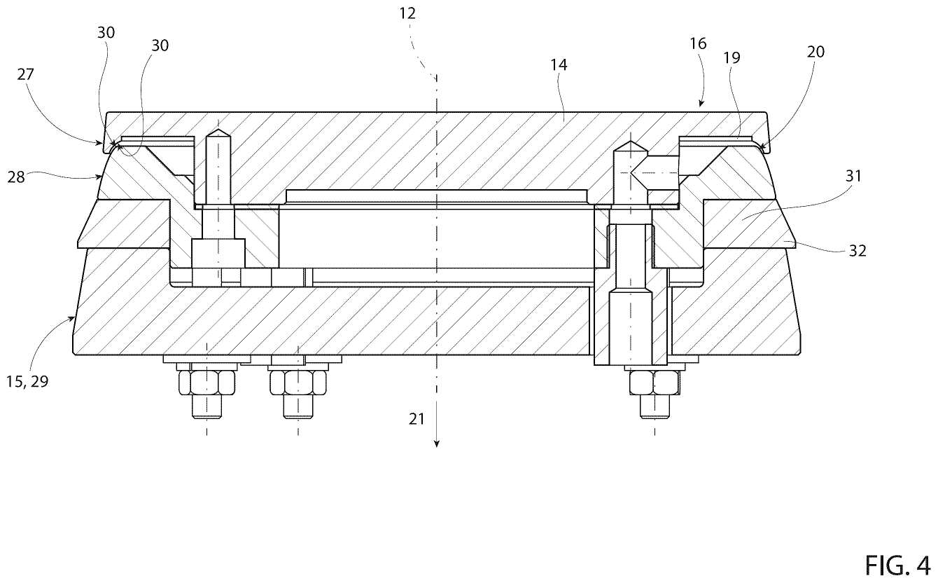

According to FIGS. 2, 3 and 4, the chamber 2 is also provided with a discharge mouth 11 with a tubular shape, which protrudes downwards from the chamber 2, has a longitudinal axis 12 and allows the products mixed by the mixing device 6 to be discharged to the outside of the chamber 2, by gravity and with the aid of the aforementioned mixing tools (not shown).

The mouth 11 is delimited by an inner surface 13 having, in this specific case, a circular shape and is associated with a closing cap 14, which is delimited by an outer surface 15 having, in this specific case, a circular shape and is movable, due to the thrust of a known operating device that is not shown herein, between an opening position and a closing position for opening and closing the mouth 11.

Obviously, according to variants that are not shown herein, the surface 13 of the mouth 11 and the surface 15 of the cap 14 have a shape other than the circular shape, for example an elliptical or polygonal shape.

The apparatus 1 further comprises a pneumatic blowing unit 16 for feeding, in this specific case, two compressed air flows along at least part of the surface 13 of the mouth 11 and along at least part of the surface 15 of the cap 14 and for removing the products accumulated on the surface 13 of the mouth 11 and on the surface 15 of the cap 14 during the discharge of the products through the mouth 11.

The unit 16 comprises a first manifold 17, which is closed like a ring around the axis 12, is obtained in the mouth 11 and communicates with the outside through a first outlet channel 18 closed like a ring around the axis 12.

The unit 16 further comprises a second manifold 19, which is closed like a ring around the axis 12, is obtained in the cap 14 and communicates with the outside through a second outlet channel 20 closed like a ring around the axis 12.

The channel 18 is obtained in an intermediate point of the surface 13 of the mouth 11 and is configured to feed the compressed air flow flowing out of the manifold 17 along the surface 13 of the mouth 11.

The channel 20 is obtained in an intermediate point of the surface 15 of the cap 14 and is configured to feed the compressed air flow flowing out of the manifold 19 along the surface 15 of the cap 14.

With reference to what described above, it should be pointed out that:
the outlet channels 18, 20, the surface 13 of the mouth 11 and the surface 15 of the cap 14 are configured to allow the compressed air flows fed through the channels 18, 20 to follow the surface 13 of the mouth 11 and the surface 15 of the cap 14 due to Coanda effect;
the channel 18 is obtained downstream of the channel 20 in a feeding direction 21 of the product along the mouth 11; and
each channel 18, 20 has the shape of a continuous ring closed around the axis 12 or comprises a plurality of elongated slots evenly distributed around the axis 12.

The surface 13 of the mouth 11 comprises a first portion 22 with the shape of a truncated cone diverging relative to the axis 12 in the direction 21; and a second portion 23 with a curved shape, which is obtained downstream of the first portion 22 in the direction 21 and is separated from the first portion 22 by the channel 18.

The second portion 23 comprises, one after the other and in the following order in the direction 21, a first large segment 24, a second narrow segment 25 and a third large segment 26. The segment 25 has a passage section for the products that is smaller than both a passage section of the segment 24 and a passage section of the segment 26.

The surface 15 of the cap 14 comprises a first portion 27 with the shape of a truncated cone diverging relative to the axis 12 in the direction 21; a second portion 28 with a curved shape, which is obtained downstream of the first portion 27 in the direction 21 and is separated from the first portion 27 by the channel 20; and a third portion 29 with the shape of a truncated cone diverging relative to the axis 12 in the direction 21 and obtained downstream of the second portion 28 in the direction 21.

The channel 18 converges towards the axis 12 so as to feed a first compressed air flow along the surface 13 of the mouth 11; and the channel 20 diverges from the axis 12 so as to feed a second compressed air flow along the surface 15 of the cap 14.

Each channel 18, 20 is delimited by two annular side surfaces 30, which have a curved shape, face one another and further have respective concavities having the same orientation.

The surfaces 30 are configured so that each channel 18, 20 has a decreasing passage section from the inlet to the outlet of the channel 18, 20.

The cap 14 is provided with an annular gasket 31, which is mounted on the surface 15 of the cap 14 downstream of the channels 18, 20 in the direction 21, is arranged between the portions 28 and 29 and has a lip 32 protruding from the surface 15 so as to be hermetically coupled, in a fluid-tight manner, to the surface 13 of the mouth 11.

In use, the compressed air flows fed through the outlet channels 18, 20 allow for a removal of the products accumulated on the surface 13 of the mouth 11 downstream of the channel 18 in the direction 21 and on the surface 15 of the cap 14 downstream of the channel 20 in the direction 21.

Furthermore, after having closed the cap 14, the compressed air flows fed through the outlet channels 18, 20 are deflected by the lip 32 of the gasket 31 in the direction contrary to the direction 21 so as to remove the products accumulated on the surface 13 of the mouth 11 upstream of the channel 18 in the direction 21 and on the surface 15 of the cap 14 upstream of the channel 20 in the direction 21.

According to a variant which is not shown herein, the gasket 31 is eliminated.

With reference to what described above, it should be pointed out that:
the activation of the pneumatic unit 16 when the cap 14 is in its open position helps the products be discharged through the mouth 11 and hinders the accumulation of the products on the surface 13 of the mouth 11 and on the surface 15 of the cap 14;
the pneumatic unit 16 is selectively operated in a continuous or intermittent manner when the cap 14 is in its opening position so as to generate a continuous or pulsed air flow on the surfaces 13 and/or 15; and
the pneumatic unit 16 can be operated before the cap 14 is opened and can be deactivated after the cap 14 is closed.

1. An apparatus for the treatment of powder, grain, paste products or the like comprising a treatment chamber; a loading mouth to feed at least one powder, grain product or the like into the treatment chamber; a discharge mouth with a tubular shape to discharge at least said product outside the treatment chamber; a closing cap, which is movable between an opening position and a closing position opening and closing the discharge mouth; and a pneumatic unit to feed at least one compressed air flow along at least part of an inner surface of the discharge mouth and/or along at least part of an outer surface of the closing cap and to remove said product from the inner surface of the discharge mouth and/or from the outer surface of the closing cap; and characterized in that the pneumatic unit comprises at least one annular manifold, which is obtained in the discharge mouth or in the closing cap, is closed like a ring around a longitudinal axis of the discharge mouth and communicates with the outside through an outlet channel, which extends around said longitudinal axis and is configured to feed the compressed air flow flowing out of the manifold along the inner surface of the discharge mouth and/or along the outer surface of the closing cap.

2. The apparatus according to claim 1, wherein each outlet channel is obtained in an intermediate point of the inner surface of the discharge mouth and/or of the outer surface of the closing cap.

3. The apparatus according to claim 1, wherein each outlet channel, the inner surface of the discharge mouth and the outer surface of the closing cap are configured to allow the relative compressed air flow to follow the inner surface of the discharge mouth and the outer surface of the closing cap due to Coanda effect.

4. The apparatus according to claim 1, wherein each outlet channel is delimited by two annular side surfaces, which have a curved shape, face one another and further have respective concavities having the same orientation.

5. The apparatus according to claim 4, wherein the side surfaces of each outlet channel are configured so that the outlet channel has a decreasing passage section from the inlet to the outlet of the outlet channel itself.

6. The apparatus according to claim 1, wherein the pneumatic unit comprises a first annular manifold obtained in the discharge mouth and communicating with the outside through a first annular outlet channel and a second annular manifold obtained in the closing cap and communicating with the outside through a second annular outlet channel.

7. The apparatus according to claim 6, wherein the first outlet channel is obtained downstream of the second outlet channel in a feeding direction of the product along the discharge mouth.

8. The apparatus according to claim 6, wherein the first outlet channel converges towards the longitudinal axis so as to feed a first compressed air flow along the inner surface of the discharge mouth.

9. The apparatus according to claim 6, wherein the second outlet channel diverges from the longitudinal axis so as to feed a second compressed air flow along the outer surface of the closing cap.

10. The apparatus according to claim 6, wherein the closing cap is provided with an annular gasket, which is mounted on the outer surface of the closing cap and has a lip protruding from the outer surface of the closing cap so as to be hermetically coupled, in a fluid-tight manner, to the inner surface of the discharge mouth.

11. The apparatus according to claim 10, wherein the gasket is mounted downstream of the first outlet channel in said feeding direction.

12. The apparatus according to claim 1, wherein the inner surface of the discharge mouth comprises a first portion with the shape of a truncated cone diverging relative to said longitudinal axis in a feeding direction of the product along the discharge mouth, and a second portion with a curved shape, which is obtained downstream of the first portion in the feeding direction and is separated from the first portion by the outlet channel.

13. The apparatus according to claim 12, wherein the second portion comprises, in succession and in the following order in said feeding direction, a first segment, a second segment and a third segment; the second segment having a smaller passage section than a passage section of the first segment and than a passage section of the third segment.

14. The apparatus according to claim 1, wherein the outer surface of the closing cap comprises a first portion with the shape of a truncated cone diverging relative to said longitudinal axis in a feeding direction of the product through the discharge mouth; and a second portion with a curved shape, which is obtained downstream of the first portion in the feeding direction and is separated from the first portion by the outlet channel.

15. The apparatus according to claim 14, wherein the outer surface of the closing cap further comprises a third portion, in particular with the shape of a truncated cone diverging relative to said longitudinal axis in the feeding direction, obtained downstream of the second portion in the feeding direction.

16. The apparatus according to claim 15, wherein the closing cap is provided with an annular gasket, which is mounted between said second and third portions and has a lip protruding from the outer surface of the closing cap so as to be hermetically coupled, in a fluid-tight manner, to the inner surface of the discharge mouth.

17. The apparatus according to claim 1, wherein the treatment chamber is a mixing chamber, which is engaged, in a rotary manner, by a transmission shaft provided with a plurality of mixing tools distributed along the transmission shaft.

18. The apparatus according to claim 1, wherein each outlet channel has the shape of a continuous ring closed around the longitudinal axis or comprises a plurality of elongated slots evenly distributed around the longitudinal axis.
